(19) United States
(12) Patent Application Publication
(10) Pub. No.: US 2021/0232286 A1
(43) Pub. Date: Jul. 29, 2021

(54) CONTROL EXECUTION METHOD AND DEVICE, STORAGE MEDIUM AND ELECTRONIC APPARATUS

(71) Applicant: ZTE CORPORATION, Ehenzhen, Guangdong (CN)

(72) Inventors: Baisheng ZHANG, Shenzhen, Guangdong (CN); Liting LIU, Shenzhen, Guangdong (CN)

(21) Appl. No.: 16/966,609

(22) PCT Filed: Jan. 23, 2019
(86) PCT No.: PCT/CN2019/072831

§ 371 Date: Apr. 13, 2021

(30) Foreign Application Priority Data
Feb. 2, 2018 (CN) 201810108193.0

(51) Int. Cl. G06F 3/041; G06F 3/043; G06F 11/34; G06K 9/00

(52) U.S. Cl. CPC G06F 3/04166; G06F 3/0436; G06K 9/0002; G06K 9/00087; G06F 11/3438

(57) ABSTRACT

Embodiments of the present disclosure provide a control execution method and device, a storage medium and an electronic apparatus. The method includes: determining a movement trend of a fingerprint detected on a fingerprint recognition region; and executing control corresponding to the movement trend.

### TECHNICAL FIELD

The present application relates to the field of communications, and in particular to a control execution method and device, a storage medium and an electronic apparatus.

### BACKGROUND

Currently, fingerprint sensors have been widely applied to terminals (e.g., smart phones). With a fingerprint sensor, an identity of a terminal user can be effectively verified. For example, the fingerprint sensor is used to unlock a screen after the screen is locked, or used for payment. However, in the related art, extended functions of the fingerprint sensor are relatively limited, because it can only implement some simple extended functions by pressing twice quickly or by pressing for a longer time, but cannot implement multi-aspect control (versatile control) of the terminal.

In view of the problem that multi-aspect control cannot be achieved by means of fingerprints in the related art, no effective solution has been proposed up to now.

### SUMMARY

Embodiments of the present disclosure provide a control execution method and device, a storage medium and an electronic apparatus that can at least solve the problem that multi-aspect control cannot be achieved by means of fingerprints in the related art.

According to an embodiment of the disclosure, there is provided a control execution method, including: determining a movement trend of a fingerprint detected on a fingerprint recognition region; and executing control corresponding to the movement trend.

According to another embodiment of the disclosure, there is further provided a control execution device, including: a determining module configured to determine a movement trend of a fingerprint detected on a fingerprint recognition region; and an execution module configured to execute control corresponding to the movement trend.

According to another embodiment of the disclosure, there is further provided a storage medium storing a computer program, wherein the computer program is configured to cause steps of the above embodiments to be implemented.

According to another embodiment of the disclosure, there is further provided an electronic apparatus, including a memory and a processor, wherein the memory stores a computer program, and the processor is configured to execute the computer program to implement steps of the method embodiment as described above.

According to the embodiments of the present disclosure, corresponding control operations can be executed according to the movement trends of the fingerprint, and different movement trends of the fingerprint can correspond to different control operations. Since the fingerprint may have various movement trends, the corresponding control operations may also be various. Therefore, multi-aspect control can be realized by means of movement trends of the fingerprint, thereby solving the problem that multi-aspect control cannot be achieved by means of fingerprints in the related art, and achieving the purpose of performing multi-aspect control by means of fingerprints.

### BRIEF DESCRIPTION OF THE DRAWINGS

The drawings described herein are intended to provide a further understanding of the present disclosure, and are intended to be a part of the present disclosure. The exemplary embodiments of the present disclosure and the description thereof are for explaining the present disclosure and do not constitute an undue limitation of the present disclosure. In the drawings:

FIG. 1 is a structural block diagram of hardware for a control execution method according to an embodiment of the present disclosure;

FIG. 2 is a flowchart of a control execution method according to an embodiment of the present disclosure;

FIG. 3 is a schematic diagram showing dividing a fingerprint into nine grids according to an embodiment of the present disclosure;

FIG. 4 is a schematic diagram showing region division of a thwartwise fingerprint according to an embodiment of the present disclosure;

FIG. 5 is a schematic diagram showing a detection region of an ultrasonic fingerprint sensor according to an optional embodiment of the present disclosure;

FIG. 6 is a schematic diagram showing dividing the detection region into nine grids according to an optional embodiment of the present disclosure;

FIG. 7 is a schematic diagram showing movements of a fingerprint in 3D space according to an optional embodiment of the present disclosure;

FIG. 8 is a fingerprint sensor according to an optional embodiment of the present disclosure;

FIG. 9 is a structural block diagram of a control execution device according to an optional embodiment of the present disclosure; and

FIG. 10 is a block diagram of system configuration of a terminal control device according to an optional embodiment of the present disclosure.

### DETAILED DESCRIPTION

The disclosure will be described in detail below with reference to the drawings and in conjunction with the embodiments. It should be noted that the embodiments of the disclosure and features therein may be combined with each other in any manner as long as they are not contradictory.

It should be also noted that terms “first”, “second”, and the like in the description, claims and drawings of the disclosure are used for the purpose of distinguishing similar objects instead of indicating a specific order or sequence.

The control execution method provided in the embodiments of the disclosure can realize multi-aspect control of the terminal. The disclosure is illustrated below by taking the terminal being a smart phone as an example. Current mobile phones with a physical keypad mainly implement multi-aspect control of the terminal through physical keys on the keypad. For example, the function of direction adjustment may be realized by five physical keys on the keypad, i.e., up, down, left, right and ok. Another terminal implements omnibearing control of the terminal by means of a circular wheel on the keypad. However, most of the existing smart phones have only one physical key, which perhaps will be gradually cancelled and replaced by only one fingerprint region (fingerprint recognition region). The fingerprint region may realize an effect of simulate pressing through a virtual vibration feedback, but only using the fingerprint cannot realize multi-aspect control of the terminal any more. Using the fingerprint technology, however, the embodiments of the disclosure can realize: an omnibearing rocker function that implements control similar to the front, back, left, right, up and down keys in the terminal. In addition, the ultrasonic fingerprint sensor may be further used to recognize a suspended fingerprint. This suspension technology may also be used in Virtual Reality (VR) and Augmented Reality (AR) scenarios for identifying a unique user and performing a suspension operation. The present disclosure will be described below with reference to specific embodiments.

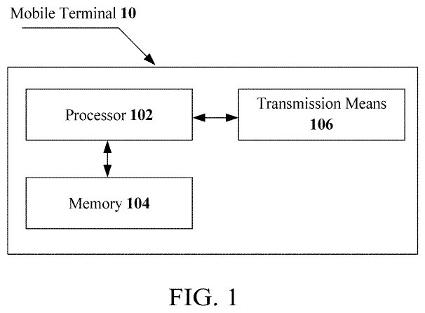

The method embodiments provided in the embodiments of the present application may be implemented in a terminal, such as a mobile terminal, a computer terminal or other similar computing devices. Taking running on a mobile terminal as an example, FIG. 1 is a structural block diagram of hardware in a mobile terminal for a control execution method according to an embodiment of the present disclosure. As shown in FIG. 1, a mobile terminal 10 may include one or more processors 102 (only one is shown in FIG. 1) (the processor 102 may include, but is not limited to, a microprocessor (MCU) or a processing device of a programmable logic device such as FPGA), a memory 104 configured to store data and a transmission means 106 configured for a communication function. It will be understood by those ordinary skilled in the art that the structure shown in FIG. 1 is merely illustrative, and does not form any limitation to the structure of the above electronic apparatus. For example, the mobile terminal 10 may include more or fewer components than those shown in FIG. 1, or have a different configuration than that shown in FIG. 1.

The memory 104 may be configured to store software programs of application software and modules, such as program instructions/modules corresponding to the control execution method in the embodiments of the present disclosure. The processor 102 executes the software programs and implements modules stored in the memory 104 to perform various functional applications and data processing, that is, to implement the above method. The memory 104 may include a high speed random access memory and may also include a non-transitory storage medium such as one or more magnetic storage devices, flash memories, or other non-transitory solid state memories. In some examples, the memory 104 may further include a memory remotely located relative to the processor 102, which may be connected to the mobile terminal 10 via a network. Examples of such networks include, but are not limited to, the Internet, Intranets, Local area networks, Mobile communication networks, and combinations thereof.

The transmission means 106 is configured to receive or transmit data via a network. Specific examples of such networks may include a wireless network provided by a communication provider of the mobile terminal 10. In an example, the transmission device 106 includes a Network Interface Controller (NIC) that may be connected to another network device through a base station to communicate with the Internet. In an example, the transmission device 106 may be a Radio Frequency (RF) module configured to communicate with the Internet wirelessly.

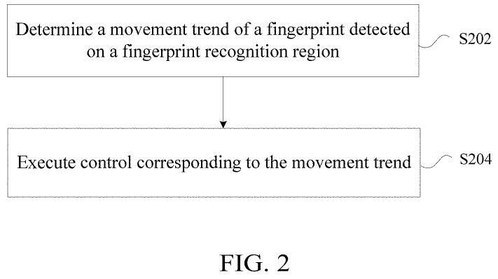

In this embodiment, a control execution method run on the above mobile terminal is provided. FIG. 2 is a flowchart of a control execution method according to an embodiment of the present disclosure. As shown in FIG. 2, the flow includes the following steps S202 to S204.

At step S202, determining a movement trend of a fingerprint detected on a fingerprint recognition region.

At step S204, executing control corresponding to the movement trend.

According to the embodiments of the present disclosure, corresponding control operations can be executed according to the movement trends of the fingerprint, and different movement trends of the fingerprint can correspond to different control operations. Since the fingerprint may have various movement trends, the corresponding control operations may also be various. Therefore, multi-aspect control can be realized by means of movement trends of the fingerprint, thereby solving the problem that multi-aspect control cannot be achieved by means of fingerprints in the related art, and achieving the purpose of performing multi-aspect control by means of fingerprints.

In an optional embodiment, the step of executing control corresponding to the movement trend includes: determining a control instruction corresponding to the movement trend; and controlling a preset terminal by the control instruction. The corresponding control instruction may be similar to a clicking and sliding operation on the display screen of the terminal so that when the user is inconvenient to click or slide on the display screen with a finger, the purpose of turning a page of the terminal can be achieved by adopting the solution of the embodiments of the disclosure, and the problem that a page of the terminal can be turned only by touching the display screen by a finger of the user in the related art is solved.

In an optional embodiment, the step of determining the movement trend of the fingerprint detected on the fingerprint recognition region includes: determining the movement trend of the detected fingerprint under the condition that the detected fingerprint matches a pre-enrolled fingerprint. In the embodiment of the disclosure, validity of the fingerprint needs to be checked, and only a pre-enrolled fingerprint (e.g., a fingerprint which has been registered in the terminal) is valid, thereby ensuring security in operations of the terminal. Apparently, in practical applications, the validity of the fingerprint may be not checked according to actual situations. That is, any operator can perform control operations, but this operation mode has low security. Preferably, the validity of the fingerprint is checked.

In an optional embodiment, the step of determining the movement trend of the fingerprint detected on the fingerprint recognition region includes: determining, by a fingerprint sensor, region change information of a region corresponding to the detected fingerprint on the fingerprint recognition region, and/or determining distance change information of a distance from the detected fingerprint (finger) to the fingerprint recognition region; and determining the movement trend of the detected fingerprint relative to the terminal based on the determined region change information and/or the determined distance change information. In this embodiment, for determining the region change information, the fingerprint sensor may be a general fingerprint sensor that requires fingerprint contact to perform fingerprint recognition, or may be a fingerprint sensor that performs fingerprint recognition without fingerprint contact, for example, an ultrasonic fingerprint sensor that performs fingerprint recognition via ultrasonic waves. Alternatively, in order to avoid erroneous operations, when the fingerprint sensor in the terminal is used to determine region change information of a region corresponding to the detected fingerprint on the fingerprint recognition region, a certain threshold may be set for a change amplitude of the region, and only a region change exceeding a certain change amplitude is regarded as valid region change information. In an optional embodiment, the step of determining the movement trend of the fingerprint detected on the fingerprint recognition region includes: determining the movement trend of the fingerprint when it is recognized that a amplitude of movement of the fingerprint detected on the fingerprint recognition region exceeds a preset threshold. This embodiment is described below with reference to specific embodiments:

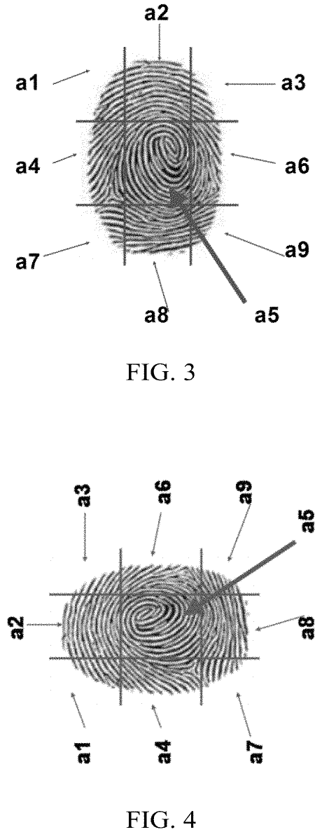

FIG. 3 is a schematic diagram showing dividing a fingerprint into nine grids according to an embodiment of the present disclosure. As shown in FIG. 3, the collected fingerprint information is firstly divided into different regions, for example, into nine grids (3×3), and then stored and identified. When the fingerprint information moves in the range of the fingerprint recognition region, a moving direction of the fingerprint can be determined according to a change trend of the region corresponding to the fingerprint, so as to trigger the terminal system to make a sliding response in the corresponding direction. For example, in normal cases, portion a5 of the fingerprint is detected to be presented at a center of the sensor by the fingerprint sensor. When the fingerprint sensor detects that portion a5 of the fingerprint is presented at portion a2 of the fingerprint, and portion a8 of the fingerprint is presented at portion a5 of the fingerprint, it indicates that the finger has performed an upward movement, and thus as a respond to this upward sliding event, the terminal interface moves upward. For a more accurate moving direction, an additional reference may be made to the changes in portions a4, a7, a6, and a9.

In an optional embodiment, an effective monitoring region of the sensor may be a region thereabove having a size of a fingerprint. The fingerprint sensor is generally located at a lower middle position of the terminal, and most users use their thumbs to operate the fingerprint sensor. In this case, the finger is usually thwartwise and the corresponding fingerprint is as shown in FIG. 4. FIG. 4 is a schematic diagram showing region division of a thwartwise fingerprint according to an embodiment of the present disclosure. The fingerprint sensor is capable of detecting fingerprint information in each portion of the 9 regions. When a center of the fingerprint corresponds to a center of the fingerprint sensor, it is a standard starting position. It is typically started at this position when the user is not operating or is ready to operate. When the user's finger is moved upward, the sensor may detect a movement trend of the fingerprint in the vertical three columns:

(1) The fingerprint in region a6 is moved out of the range, the fingerprint in region a5 is moved to region a6, and the fingerprint in region a4 is moved to region a5.

(2) If the movement continues, the fingerprint in region a6 is moved out of the range, and the fingerprint in region a5 is moved to region a6.

(3) If the movement still continues, the fingerprint in region a6 is moved out of the range. At this time, the sensor cannot detect any fingerprint any more.

Similarly, a1, a2, a3 and a7, a8, a9 are also moved in the same way. According to such information, the fingerprint sensor knows that the user performs a sliding-up operation and then triggers a sliding-up event, and an application on the mobile phone performs a corresponding moving effect after receiving the event.

The above embodiment taking an upward movement as an example, but downward, leftward and rightward movements or movements to upward left, downward left, upward right and downward right are also similar.

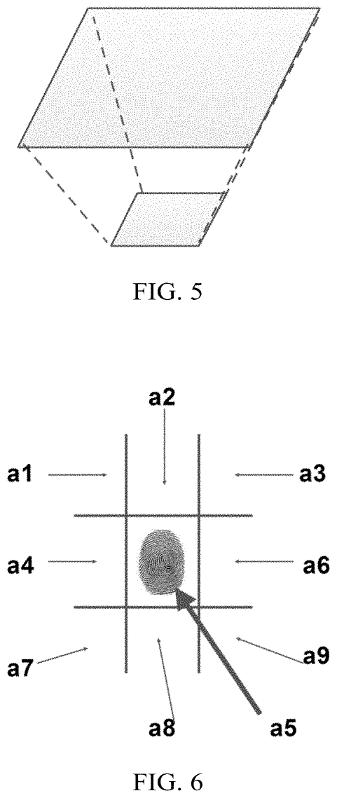

In an optional embodiment, a common fingerprint sensor may have a detection region limited to the size of a fingerprint, while an ultrasonic fingerprint sensor is not limited by the size of the fingerprint. When an ultrasonic fingerprint sensor is applied, the fingerprint detection region may be far larger than the fingerprint size. FIG. 5 is a schematic diagram showing a detection region of an ultrasonic fingerprint sensor according to an embodiment of the present disclosure. As shown in FIG. 5, since the fingerprint sensor is detected by ultrasonic waves, the detection range may be much larger than a size of the ultrasonic fingerprint sensor. In case of such usage scenarios, movement detection can still be implemented by: dividing the detection region into 9 parts similarly. In this case, information of the entire fingerprint, not a part thereof, is detected. FIG. 6 is a schematic diagram showing dividing the detection region into nine grids (3×3) according to an embodiment of the present disclosure. When a fingerprint is moved from a5 to a2, the ultrasonic fingerprint sensor is able to detect this trend. The ultrasonic fingerprint sensor is a type of fingerprint sensor which utilizes a detection principle of obtaining fingerprint information by sending, feeding back and receiving ultrasonic waves. Ultrasonic waves can penetrate the finger epidermal layer to obtain the fingerprint information in the corium layer without affecting by water droplet, sweat drops, oil stains, and the like. Therefore, ultrasonic fingerprint sensor is more accurate and sensitive than conventional fingerprint sensors. Meanwhile, due to the fact that the ultrasonic technology can penetrate glass, plastic, steel and aluminum products and the like, when collecting a fingerprint of a finger, the finger does not need to touch the fingerprint region, but may be hung in air. Since ultrasonic waves have a wider transmission range when emitted, fingerprints can be sensed in a wider range.

In the above embodiment, distance change information of a distance of the fingerprint to the fingerprint recognition region can be detected by an ultrasonic fingerprint sensor, and in order to avoid erroneous operations, when the fingerprint sensor in the terminal is used to determine a distance from the detected fingerprint to the fingerprint recognition region, a certain threshold may be set for a change amplitude of the distance, and only distance change information exceeding the certain distance change amplitude is regarded as valid distance change information.

In an optional embodiment, the movement trend of the detected fingerprint determined from the determined region change information includes one of an upward movement, a downward movement, a leftward movement, and a rightward movement; and/or, the movement trend of the detected fingerprint determined from the determined distance change information includes a forward movement that reduces the distance to the fingerprint recognition region or a backward movement that increases the distance to the fingerprint recognition region.

In an optional embodiment, the step of determining the distance change information of the distance from the detected fingerprint to the fingerprint recognition region by the fingerprint sensor includes: determining that the distance change information indicates an increased distance when a time period detected by the fingerprint sensor from emission to return of a signal emitted from the fingerprint sensor becomes longer; and/or, determining that the distance change information indicates an decreased distance when a time period detected by the fingerprint sensor from emission to return of a signal emitted from the fingerprint sensor becomes shorter. In this embodiment, the fingerprint sensor may be an ultrasonic fingerprint sensor as described above, and the signal emitted from the fingerprint sensor may be ultrasonic waves.

This embodiment is described below with reference to specific embodiments:

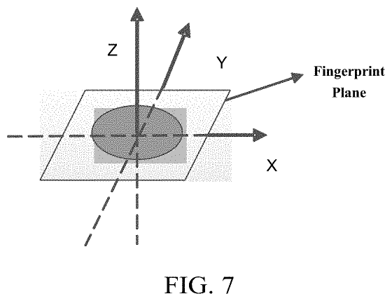

As can be seen from the above embodiments, in addition to movement in the x, y two-dimensional plane, the embodiments of the present disclosure may support movement in the z direction, i.e. in the vertical direction. FIG. 7 is a regional schematic diagram showing movements of a fingerprint in 3D space according to an optional embodiment of the present disclosure. When the fingerprint plane keeps unchanged in the x and y directions but is moved upward in the z direction, the fingerprint sensor (i.e., the ultrasonic fingerprint sensor) will detect that a time period from emission of the ultrasonic waves to receipt of a feedback is gradually prolonged. Thus, it is known that the finger of the user is moving upward. Similarly, when the finger is moving downward in the z direction, the fingerprint sensor will detect that a time period from emission of the ultrasonic waves to receipt of a feedback is shortened, which indicates that the finger of the user is moved downward. According to this trend, an effect similar to forcibly pressing on and lifting from a pressure screen can be obtained, or an effect of clicking, double clicking, and continuous clicking the screen can be obtained. Apparently, other control instructions may also be configured.

In an embodiment of the present disclosure there is provided a method for implementing a sliding event by a fingerprint sensor in combination with finger movements through the following steps, which will be further described with reference to the accompanying drawings.

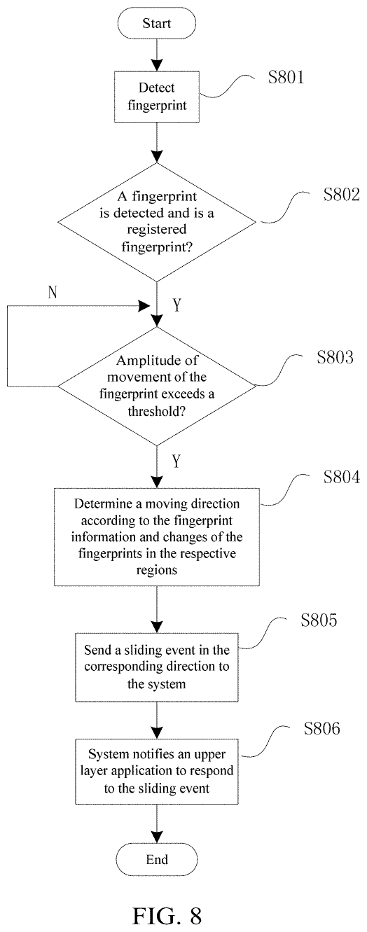

As shown in FIG. 8, the method includes the following steps S801 to S806.

At step S801: detecting a fingerprint. The purpose of the step is to periodically detect whether any fingerprint is present above the fingerprint sensor. If not, the periodic detection is continued, and if yes, proceed to step S802.

At step S802: a fingerprint is detected and the detected fingerprint is a registered fingerprint. This step is used for determining whether the detected fingerprint is registered. Information matching and movement trend judgement are performed for a registered fingerprint only, while an unregistered fingerprint is not processed.

At step S803: determining whether an amplitude of movement of the fingerprint exceeds a threshold. In this step, the fingerprint information may be divided into 9 parts, in each of which the fingerprint is moved in a respective region. A preset threshold is provided for the amplitude of movement, such as half of each region. If the amplitude of movement exceeds half of the region, it indicates that step S804 is to be performed for judgment and analysis; and if not, monitoring on changes in the amplitude is continued.

At step S804: determining a moving direction according to the fingerprint information in the respective regions and changes of the fingerprints in each of the regions. In this step, different parts of the fingerprint continuously appear in the respective regions in the same direction, which indicates that the fingerprint is moved in that direction.

At step S805: sending a sliding event in the corresponding direction to the system. In this step, the fingerprint sensor, as an input device, triggers a sliding event notification in a moving direction to the system. The system then performs further processing in step S806.

At step S806: the system notifies an upper layer application to respond to the sliding event. In this step, the system receives the sliding event reported by the input device and notifies an upper layer application of the standard sliding event. The application makes a response after receiving the standard sliding event.

Through the description of the above implementations, those skilled in the art can clearly understand that the method according to the above embodiment may be implemented by means of software plus a necessary general hardware platform. Obviously, it may also be implemented by hardware, but in most cases, the former is preferable. Based on such understanding, part of the technical solution of the present disclosure, which is essential or contributes to the prior art, may be embodied in the form of a software product. The computer software product is stored in a storage medium (such as a ROM/RAM, a disk, or an optical disc) and includes a number of instructions for causing a terminal device (which may be a mobile phone, a computer, a server, or a network device, etc.) to perform the methods of various embodiments of the present disclosure.

This embodiment further provides a control execution device to implement the above embodiments and preferable implementations. Details which have been explained will not be repeated here. As used herein, the term “module” may be a combination of software and/or hardware that can realize a preset function. The devices described in the following embodiments are preferably implemented in software, but hardware, or a combination of software and hardware, is also possible and contemplated.

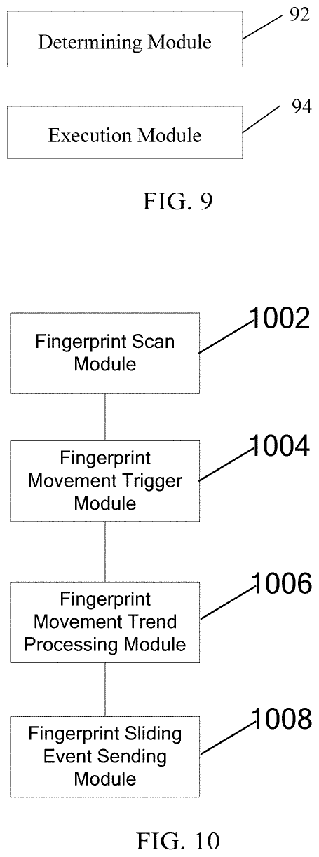

FIG. 9 is a structural block diagram of a control execution device according to an embodiment of the present disclosure. As shown in FIG. 9, the device includes: a determining module 92 configured to determine a movement trend of a fingerprint detected on a fingerprint recognition region; and an execution module 94 connected to the determining module 92 and configured to executing control corresponding to the movement trend.

In an optional embodiment, the execution module 94 includes: a first determining unit configured to determine a control instruction corresponding to the movement trend; and a control unit configured to control a preset terminal by the control instruction.

In an optional embodiment, the determining module 92 includes: a second determining unit configured to determine the movement trend of the detected fingerprint under the condition that the detected fingerprint matches a pre-enrolled fingerprint.

In an optional embodiment, the determining module 92 includes: a third determining unit configured to determine, by a fingerprint sensor, region change information of a region corresponding to the detected fingerprint on the fingerprint recognition region, and/or determine, by the fingerprint sensor, distance change information of a distance from the detected fingerprint to the fingerprint recognition region; and a fourth determining unit configured to determine the movement trend of the detected fingerprint based on the determined region change information and/or the determined distance change information.

In an optional embodiment, the movement trend of the detected fingerprint determined from the determined region change information includes one of an upward movement, a downward movement, a leftward movement, and a rightward movement; and/or, the movement trend of the detected fingerprint determined from the determined distance change information includes a forward movement that reduces the distance to the fingerprint recognition region or a backward movement that increases the distance to the fingerprint recognition region.

In an optional embodiment, the third determining unit determines the distance change information of the distance from the detected fingerprint to the fingerprint recognition region in the following manner: determining that the distance change information indicates an increased distance when a time period detected by the fingerprint sensor from emission to return of a signal emitted from the ultrasonic fingerprint sensor becomes longer; and/or, determining that the distance change information indicates an decreased distance when a time period detected by the fingerprint sensor from emission to return of a signal emitted from the fingerprint sensor becomes shorter.

In an optional embodiment, the determining module 92 is specifically configured to: determine the movement trend of the fingerprint when it is recognized that a amplitude of movement of the fingerprint detected on the fingerprint recognition region exceeds a preset threshold.

FIG. 10 is a block diagram of system configuration of a terminal control device according to an embodiment of the present disclosure. As shown in FIG. 10, the device includes a fingerprint scan module 1002 configured to periodically detect whether a fingerprint is present above the sensor. If present, and if the fingerprint has been registered, a fingerprint movement trigger module 1004 is notified to continue the detection.

The fingerprint movement trigger module 1004 is configured to detect whether the fingerprint is moved. This is determined from a change extent of each region of the fingerprint in the region. If the amplitude of movement exceeds a certain preset threshold, a fingerprint movement trend processing module 1006 (the fingerprint scan module 1002, the fingerprint movement trigger module 1004, and the fingerprint movement trend processing module 1006 correspond to the first determining module 92) is notified to perform further detection processing.

The fingerprint movement trend processing module 1006 is configured to detect changes in the fingerprint of each region. For example, if the above-mentioned upward movement occurs, the module derives a moving direction from changes of the fingerprint in each region, and then passes the direction to a fingerprint sliding event sending module 1008 (corresponding to the second determining module 94 and the control module 96 described above).

The fingerprint sliding event sending module 1008 simulates the operation in the moving direction as a sliding event that can be identified by the operating system and then sends the sliding event to the terminal system. After receiving the event, the terminal generates a sliding effect on the current application.

It should be noted that each of the above modules may be implemented by software or hardware. For the latter, it may be implemented by, but are not limited to: all of the above modules are located in the same processor; or, the above modules are located in different processors in any combination.

In an embodiment of the present disclosure, there is further provided a storage medium storing a computer program. The computer program is configured to cause steps of any one of the above method embodiments to be implemented.

Optionally, in the present embodiment, the storage medium may include, but is not limited to: a U disk, a read-only memory (ROM), a random access memory (RAM), a mobile hard disk, a disk or optical disk, and other media that can store a program code.

According to still another embodiment of the disclosure, there is further provided an electronic apparatus, including a memory and a processor. The memory stores a computer program, and the processor is configured to execute the computer program to perform steps of any of the method embodiments as described above.

Optionally, the electronic apparatus may further include a transmission device and an input-output device. The transmission device is coupled to the processor, and the input-output device is coupled to the processor.

Obviously, a person skilled in the art would understand that the above modules and steps of the present disclosure can be realized by using a universal computing device, can be integrated in a single computing device or distributed on a network that consists of a plurality of computing devices; and alternatively, they can be realized by using the executable program code of the computing device, so that they can be stored in a storage device and executed by the computing device, in some cases, can perform the shown or described steps in a sequence other than herein, or they are made into various integrated circuit modules respectively, or a plurality of modules or steps thereof are made into a single integrated circuit module, thus to be realized. In this way, the present disclosure is not restricted to any particular hardware and software combination.

The descriptions above are only preferred embodiments of the present disclosure, which are not used to restrict the present disclosure. For those skilled in the art, the present disclosure may have various changes and variations. Any amendments, equivalent substitutions, improvements, etc. within the principle of the disclosure are all included in the scope of the protection defined by the appended claims of the disclosure.

### INDUSTRIAL APPLICABILITY

As described above, the control execution method and device, the storage medium and the electronic apparatus provided in the embodiments of the present disclosure have the following beneficial effects: solving the problem that multi-aspect control cannot be achieved by means of fingerprints in the related art, and achieving the purpose of performing multi-aspect control by means of fingerprints.

1. A control execution method, comprising:
determining a movement trend of a fingerprint detected on a fingerprint recognition region; and
executing control corresponding to the movement trend.

2. The method according to claim 1, wherein the step of executing control corresponding to the movement trend comprises:
determining a control instruction corresponding to the movement trend; and
controlling a preset terminal by the control instruction.

3. The method according to claim 1, wherein the step of determining the movement trend of the fingerprint detected on the fingerprint recognition region comprises:
determining the movement trend of the detected fingerprint under the condition that the detected fingerprint matches a pre-enrolled fingerprint.

4. The method according to claim 1, wherein the step of determining the movement trend of the fingerprint detected on the fingerprint recognition region comprises:
determining, by a fingerprint sensor, region change information of a region corresponding to the detected fingerprint on the fingerprint recognition region, and/or determining, by a fingerprint sensor, distance change information of a distance from the detected fingerprint to the fingerprint recognition region; and
determining the movement trend of the detected fingerprint based on the determined region change information and/or the determined distance change information.

5. The method according to claim 4, wherein
the movement trend of the detected fingerprint determined from the determined region change information comprises one of an upward movement, a downward movement, a leftward movement, and a rightward movement; and/or,
the movement trend of the detected fingerprint determined from the determined distance change information comprises a forward movement that reduces the distance to the fingerprint recognition region or a backward movement that increases the distance to the fingerprint recognition region.

6. The method according to claim 5, wherein the step of determining, by the fingerprint sensor, the distance change information of the distance from the detected fingerprint to the fingerprint recognition region comprises:
determining that the distance change information indicates an increased distance when a time period detected by the fingerprint sensor from emission to return of a signal emitted from the fingerprint sensor becomes longer; and/or,
determining that the distance change information indicates a decreased distance when a time period detected by the fingerprint sensor from emission to return of a signal emitted from the fingerprint sensor becomes shorter.

7. The method according to claim 1, wherein the step of determining the movement trend of the fingerprint detected on the fingerprint recognition region comprises:
determining the movement trend of the fingerprint when it is recognized that a amplitude of movement of the fingerprint detected on the fingerprint recognition region exceeds a preset threshold.

8. A control execution device, comprising:
a determining module configured to determine a movement trend of a fingerprint detected on a fingerprint recognition region; and
an execution module configured to execute control corresponding to the movement trend.

9. The device according to claim 8, wherein the execution module comprises:
a first determining unit configured to determine a control instruction corresponding to the movement trend; and
a control unit configured to control a preset terminal by the control instruction.

10. The device according to claim 8, wherein the determining module comprises:
a second determining unit configured to determine the movement trend of the detected fingerprint under the condition that the detected fingerprint matches a pre-enrolled fingerprint.

11. The device according to any claim 8, wherein the determining module comprises:
a third determining unit configured to determine, by a fingerprint sensor, region change information of a region corresponding to the detected fingerprint on the fingerprint recognition region, and/or determine, by a fingerprint sensor, distance change information of a distance from the detected fingerprint to the fingerprint recognition region; and
a fourth determining unit configured to determine the movement trend of the detected fingerprint based on the determined region change information and/or the determined distance change information.

12. The device according to claim 11, wherein
the movement trend of the detected fingerprint determined from the determined region change information comprises one of an upward movement, a downward movement, a leftward movement, and a rightward movement; and/or,
the movement trend of the detected fingerprint determined from the determined distance change information comprises a forward movement that reduces the distance to the fingerprint recognition region or a backward movement that increases the distance to the fingerprint recognition region.

13. The device according to claim 12, wherein the third determining unit determines the distance change information of the distance from the detected fingerprint to the fingerprint recognition region in the following manner:
determining that the distance change information indicates an increased distance when a time period detected by the fingerprint sensor from emission to return of a signal emitted from the fingerprint sensor becomes longer; and/or,
determining that the distance change information indicates a decreased distance when a time period detected by the fingerprint sensor from emission to return of a signal emitted from the fingerprint sensor becomes shorter.

14. A non-transitory computer-readable storage medium storing a computer program, wherein the computer program is configured to, when executed, cause the method of claim 1 to be implemented.

15. An electronic apparatus, comprising a memory and a processor, wherein the memory stores a computer program, and the processor is configured to execute the computer program to implement the method of claim 1.
